(19) United States
(12) Patent Application Publication
(10) Pub. No.: US 2019/0308621 A1
(43) Pub. Date: Oct. 10, 2019

(54) TRAVELING PATH GENERATION APPARATUS AND TRAVELING PATH GENERATION METHOD

(71) Applicant: DENSO CORPORATION, Kariya-city, Aichi-pref. (JP)

(72) Inventors: Hiroshi INOU, Kariya-city, Aichi-pref. (JP); Toshiki MATSUMOTO, Kariya-city, Aichi-pref. (JP); Teppei MIYAKE, Kariya-city, Aichi-pref. (JP); Tomoyuki HORI, Kariya-city, Aichi-pref. (JP)

(21) Appl. No.: 15/781,007

(22) PCT Filed: Dec. 2, 2016
(86) PCT No.: PCT/JP2016/085970

§ 371 Date: Jun. 1, 2018

(30) Foreign Application Priority Data
Dec. 4, 2015 (JP) 2015-237541

(51) Int. Cl. B60W 30/12; B60W 40/072

(52) U.S. Cl. CPC B60W 30/12; B60W 40/072; G05D 1/0212; B60W 2550/302; B60W 2550/146

(57) ABSTRACT

A traveling path generation apparatus includes an information acquisition section, a road determination section, and a path generation section. In response to the road determination section determining that there are curved paths, the path generation section generates an expected traveling path by correcting a lane traveling path such that a radius of curvature of each cornering line exceeds a radius of curvature of the corresponding curved path.

### CROSS-REFERENCE TO RELATED APPLICATIONS

This international application claims priority to Japanese Patent Application No. 2015-237541 filed on Dec. 4, 2015, the entire contents of which are incorporated herein by reference.

### TECHNICAL FIELD

The present disclosure relates to a vehicle traveling control technique.

### BACKGROUND ART

Techniques for what is called cooperative automated driving have been proposed, such as in PTL 1 below. The cooperative automated driving utilizes, for example, road-vehicle communication between infrastructure such as roadside units and control centers and vehicles to perform traveling control of the vehicles. The technique of PTL 1 sets a traveling path or the like for a vehicle, and controls the engine, brake, and steering of the vehicle such that the vehicle travels along the set traveling path.

### CITATION LIST

### Patent Literature

[PTL 1] JP 2969175 B

### SUMMARY OF THE INVENTION

However, the inventors have found through their detailed study that if a traveling path for a vehicle only indicates the middle position of a lane, vehicle ride quality may be deteriorated when the vehicle travels along a curved path on the traveling path. Note that this kind of problem is not unique to the above-mentioned cooperative automated driving, but is common to various traveling control techniques including what is called autonomous automated driving in which, for example, determination of the condition of vehicle's surroundings and traveling control are performed only by an in-vehicle system.

The present disclosure provides a traveling control technique capable of improving vehicle ride quality and the like.

A traveling path generation apparatus according to an aspect of the present disclosure includes an information acquisition section, a road determination section, and a path generation section. The information acquisition section is configured to acquire road line shape information representing a road line shape of a lane traveling path. The lane traveling path is a path indicating a middle position of a lane (hereinafter referred to as an object lane) in which an object vehicle is traveling along a traveling path set in advance.

The road determination section is configured to determine, on the basis of the road line shape information acquired by the information acquiring section, whether there are one or more curved paths within a path range set in advance in a course direction from a current position of the object vehicle on the lane traveling path. The curved path is a curved line path defined by a radius of curvature.

When generating an expected traveling path in response to the road determination section determining that there are one or more curved paths, the path generation section is configured to set, as a cornering line, a part of an expected traveling path corresponding to each of the curved paths. Then, the path generation section is configured to generate the expected traveling path by correcting the lane traveling path such that a radius of curvature of each cornering line exceeds a radius of curvature of the corresponding curved path. The expected traveling path is a path on which the object vehicle is expected to travel along the object lane within the path range.

According to such a configuration, the radius of curvature of a cornering line on the expected traveling path is larger than the radius of curvature of the lane traveling path indicating the middle position of a lane as a traveling path for the vehicle. Therefore, according to the aspect of the present disclosure, the lateral force (hereinafter referred to as lateral acceleration) applied to the vehicle during cornering is reduced, and vehicle ride quality can be improved. In addition, according to the aspect of the present disclosure, since the lateral acceleration is reduced, tire wear can be reduced. Moreover, according to the aspect of the present disclosure, since the vehicle is relatively less decelerated, vehicle fuel consumption can be improved.

Note that, for similar reasons described above, a traveling path generation method according to an aspect of the present disclosure can achieve effects similar to the above-mentioned effects of the traveling path generation apparatus according to an aspect of the present disclosure.

### BRIEF DESCRIPTION OF DRAWINGS

FIG. 1 is a block diagram illustrating configurations of an in-vehicle system and infrastructure;

FIG. 2 is a block diagram illustrating a configuration of a control center;

FIG. 3 is a block diagram illustrating a functional configuration of a traveling path generation unit;

FIG. 4 is a schematic diagram mainly illustrating an expected traveling path and a cornering line;

FIG. 5 is a schematic diagram mainly illustrating an expected traveling path and a cornering line;

FIG. 6 is a schematic diagram mainly illustrating a first correction path and a second correction path;

FIG. 7 is a schematic diagram mainly illustrating a first correction path and a second correction path;

FIG. 8 is a flowchart illustrating a first correction path generating process;

FIG. 9 is a flowchart illustrating a second correction path generating process.

### DESCRIPTION OF EMBODIMENT

Hereinafter, exemplary embodiments of the present disclosure will be described with reference to the drawings.

### 1. First Embodiment

### 1-1. Overall Configuration

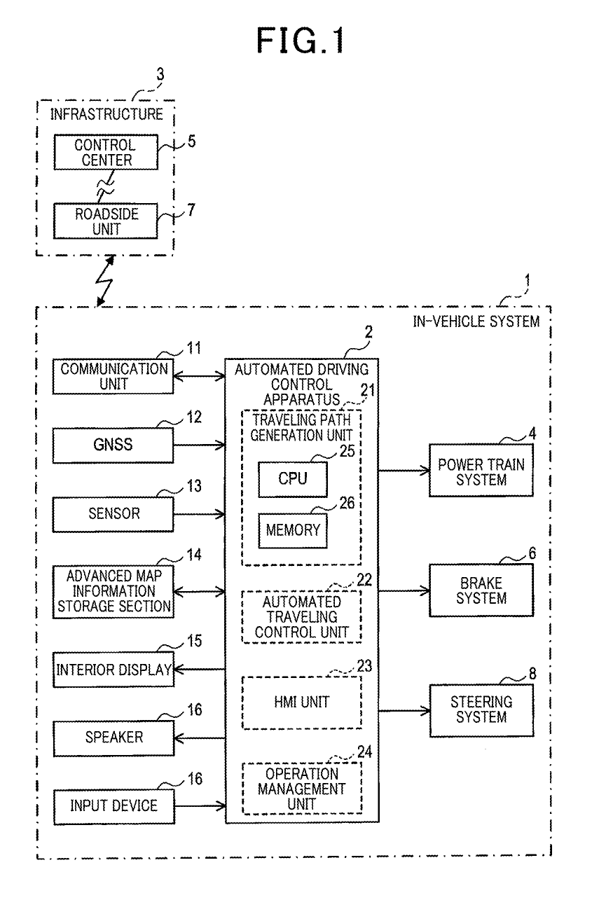

An automated driving control system illustrated in FIG. 1 includes an in-vehicle system 1 and infrastructure 3. The infrastructure 3 includes a control center 5 and a roadside unit 7.

The in-vehicle system 1 is mounted on multiple vehicles, including an own vehicle. Each of the in-vehicle systems 1 wirelessly communicates with the control center 5, for example, to set a traveling path for use in what is called automated driving. In addition to wirelessly communicating with the control center 5, for example, the in-vehicle system 1 wirelessly communicates with the roadside unit 7 installed on a traveling road (hereinafter referred to as road-vehicle communication) and wirelessly communicates with the in-vehicle systems 1 mounted on other vehicles (hereinafter referred to as inter-vehicle communication), so that they provide surrounding information representing the condition of the own vehicle and its surroundings to each other. The in-vehicle system 1 may acquire surrounding information by wirelessly communicating with mobile terminals carried by pedestrians.

The infrastructure 3 collects and integrates pieces of surrounding information to generate environmental information for use in traveling path settings or the like. The in-vehicle system 1 acquires the environmental information from the infrastructure 3, and performs traveling control in accordance with the driving action determined on the basis of the environmental information, such as acceleration, deceleration, stop, start, turning right, turning left, and lane change. In this manner, in the automated driving control system, the in-vehicle systems 1 and the infrastructure 3 cooperate with one another, so that the optimal traveling path leading to a destination is set for each vehicle, and each vehicle is controlled such that it can automatically travel along the traveling path in safety. The traveling path is a route on which a vehicle travels. The route is indicated at least by a road, and in the present embodiment further indicated by a lane on the road.

### 1-2. Configuration of In-Vehicle System 1

The in-vehicle system 1 includes a communication unit 11, a GNSS 12, a sensor 13, an advanced map information storage section 14, an interior display 15, a speaker 16, an input device 17, an automated driving control apparatus 2, a power train system 4, a brake system 6, a steering system 8, and the like.

The communication unit 11 performs, for example, inter-vehicle communication with other vehicles and road-vehicle communication with the infrastructure 3 by means of wireless communication. The GNSS 12 receives radio waves from quasi-zenith and GPS satellites to acquire, for example, positional information of the own vehicle. The sensor 13 includes an image sensor, a millimeter-wave radar, a lidar, and the like. The sensor 13 detects various objects that exist around the own vehicle such as an obstruction, another vehicle, a pedestrian, a sign, a lane boundary, and a structure. For example, on the basis of image data captured by the image sensor, the sensor 13 recognizes lane boundaries by detecting right and left white lines that define the traveling road on which the own vehicle is traveling on the basis of the difference in luminance between the white line and the road surface. For example, the sensor 13 detects the distance and relative speed to an object and the azimuth orientation of the object by using the millimeter-wave radar and the lidar. The sensor 13 includes a sensor that detects the driver's operation and the vehicle's behavior. For example, the speed, acceleration, yaw rate, and steering angle of the vehicle are detected as the vehicle's behavior.

The advanced map information storage section 14 stores advanced map information, i.e., map information associated with environmental information. The map information contains not only general road information used in a navigation system but also, for example, the width of roads, the radius of curvature of roads, the height and length of structures (described later) such as buildings and premises. The environmental information includes, for example, traveling states of other vehicles that exist within a predetermined range from the own vehicle, road conditions, traffic management information such as traffic control, and information of traffic conditions related to vehicles, pedestrians, and the like. The environmental information is updated each time when information is acquired from the infrastructure 3, other vehicles, or the like via the communication unit 11.

The interior display 15 is a display provided in the interior of the own vehicle and capable of displaying images. As the interior display 15, for example, a display that displays navigation maps or the like, a meter display, and a head-up display are used. The speaker 16 is provided in the interior of the own vehicle, and gives various types of speech guidance, alarms, and the like. The input device 17 accepts a user's input operation, and generates an input signal in accordance with the input operation.

The automated driving control apparatus 2 includes a traveling path generation unit 21, an automated traveling control unit 22, an HMI unit 23, an operation management unit 24, and the like. These units 21 to 24 mainly include a well-known microcomputer having a CPU 25 and a semiconductor memory (hereinafter referred to as a memory 26) such as a RAM, a ROM, and a flash memory, and a communication controller for an in-vehicle network. In each of the units 21 to 24, various processes are performed by the CPU 25 on the basis of a program stored in the memory 26, and once the program is executed, the method corresponding to the program is performed. Note that the units 21 to 24 may share a single microcomputer or may include their own microcomputers. The microcomputer(s) may be installed anywhere in the vehicle.

In response to the intention to utilize the automated driving function being confirmed via the input device 17, the HMI unit 23 transmits, to the infrastructure 3, a start request notification indicating, for example, the vehicle ID of the own vehicle, positional information representing the current position, and the destination for automated driving. Subsequently, the HMI unit 23 performs control to notify the driver of necessary information via the interior display 15 and the speaker 16 on the basis of various types of information such as environmental information and traveling paths transmitted from the infrastructure 3 and various types of information obtained from the sensor 13.

The operation management unit 24 generates positional information representing the current position of the own vehicle on the basis of information from the GNSS 12, and generates surrounding information such as information about various objects that exist around the own vehicle and information representing the own vehicle's behavior obtained from the sensor 13. If an object is a vehicle or a pedestrian, information about the object includes, for example, the distance to the object, the azimuth orientation and moving speed of the object, and the like. If an object is a sign, information about the object includes, for example, the contents of the sign and the like. The operation management unit 24 transmits, to the infrastructure 3 via the communication unit 11 on a regular basis, information including the positional information and the surrounding information associated with the vehicle ID for identifying the own vehicle.

The operation management unit 24 keeps advanced map information updated on the basis of the environmental information transmitted from the infrastructure 3. The operation management unit 24 sets the optimal traveling path from the current position to destination of the own vehicle on the basis of traveling paths transmitted from the infrastructure 3 and various types of information obtained from the sensor 13. The operation management unit 24 specifies the current lane, i.e., the lane on which the own vehicle is traveling, on the basis of positional information representing the current position of the own vehicle. The operation management unit 24 specifies the position of the own vehicle inside the current lane on the basis of, for example, surrounding information and a result of recognizing lane boundaries obtained from the sensor 13.

In accordance with an expected traveling path 54 output from the traveling path generation unit 21, the automated traveling control unit 22 sets, for example, the target speed, target acceleration, target steering angle, and target yaw rate at each point on the expected traveling path 54 such that the own vehicle travels along the expected traveling path 54. The automated traveling control unit 22 controls the power train system 4, the brake system 6, and the steering system 8 on the basis of these settings. Details of the expected traveling path 54 will be described later.

In a case where an internal combustion engine is mounted as a drive source, the power train system 4 controls the position of the throttle device and the amount of fuel injection in accordance with the drive output indicated by the automated traveling control unit 22. In a case where a motor is mounted as the drive source, the power train system 4 controls power supply to the motor in accordance with the drive output indicated by the automated traveling control unit 22.

The brake system 6 controls an actuator provided to a hydraulic circuit of a hydraulic brake in accordance with braking force indicated by the automated traveling control unit 22. In a case where a motor is mounted as the drive source of the vehicle, the brake system 6 may control the power supply to the motor to generate regenerative braking force in accordance with the braking force indicated by the automated traveling control unit 22.

The steering system 8 controls the direction and amount of rotation of a pinion gear provided in a steering mechanism in accordance with a steering angle indicated by the automated traveling control unit 22.

The automated driving control apparatus 2, the power train system 4, the brake system 6, and the steering system 8 are connected to an in-vehicle LAN, and share vehicle information such as the amount of control with one another over an in-vehicle LAN. The in-vehicle LAN is a local area network established inside the vehicle. For example, a well-known communication protocol such as CAN (registered trademark), FlexRay (registered trademark), LIN, MOST (registered trademark), or AVC-LAN is used as the in-vehicle LAN.

### 1-3. Configuration of Control Center 5

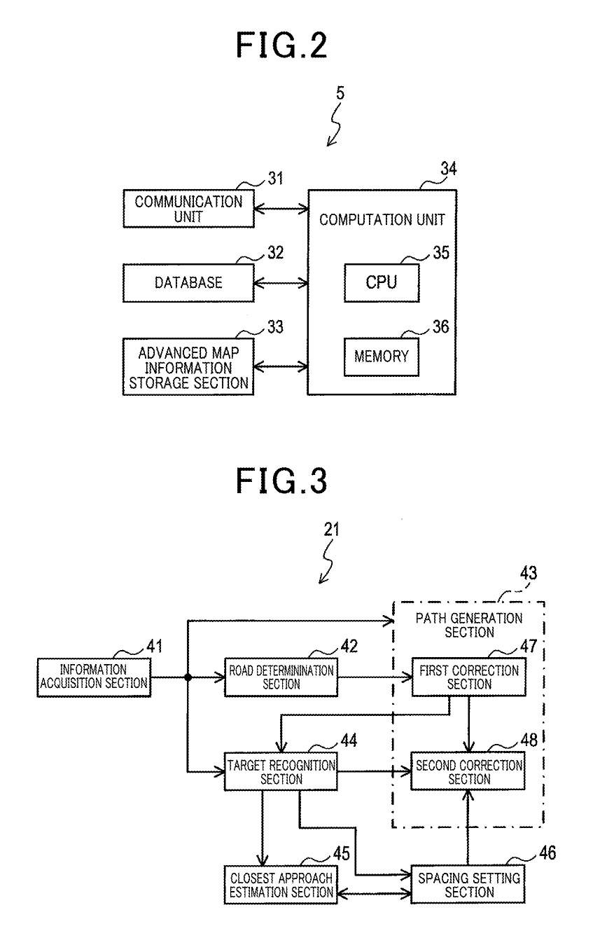

The control center 5 is a center-type apparatus that monitors and controls automated traveling of each vehicle within a predetermined area. As illustrated in FIG. 2, the control center 5 includes a communication unit 31, a database 32, an advanced map information storage unit 33, and a computation unit 34.

The communication unit 31 wirelessly communicates with the in-vehicle system 1, and communicates with the roadside unit 7 over a public telecommunication network or the like. In response to receiving a start request notification via the communication unit 31, the database 32 stores the vehicle ID, positional information, and destination indicated by the start request notification in association with one another. The advanced map information storage unit 33 stores advanced map information. The contents of the advanced map information are the same as those described in relation to the advanced map information storage section 14.

The computation unit 34 mainly includes a well-known microcomputer having a CPU 35 and a memory 36. In the computation unit 34, various processes are performed by the CPU 35 on the basis of a program stored in the memory 36, and once the program is executed, the method corresponding to the program is performed. The computation unit 34 generates environmental information by integrating pieces of surrounding information acquired from vehicles via the communication unit 31, and keeps the contents of the environmental information stored in the advanced map information storage unit 33 updated. The computation unit 34 keeps positional information of a vehicle ID registered in the database 32 updated on the basis of the vehicle ID and the positional information indicated by the surrounding information.

The computation unit 34 generates traveling paths from the current position indicated by positional information to a destination by utilizing information stored in the advanced map information storage section 33, and transmits the generated traveling paths together with environmental information related to the traveling paths to the vehicle that has transmitted a start request notification. After that, the computation unit 34 recalculates, at each update timing determined in advance, traveling paths for all the automated driving vehicles registered, and transmits the results together with the environmental information to the respective automated driving vehicles.

### 1-4. Configuration of Roadside Unit 7

The roadside unit 7 is a unit that collects pieces of surrounding information provided by vehicles through road-vehicle communication, and provides information such as traveling paths and environmental information required for automated driving to vehicles through road-vehicle communication. The roadside unit 7 is installed, for example, at an incommunicable point where it is difficult to perform wireless communication between the in-vehicle system 1 and the control center 5 or inter-vehicle communication between the in-vehicle systems 1. The roadside unit 7 includes a communication unit, a database, an advanced map information storage unit, a computation unit, and the like. The database and the advanced map information storage unit of the roadside unit 7 are similar to the database 32 and the advanced map information storage unit 33 of the control center 5. The computation unit of the roadside unit 7 performs the process of keeping the contents stored in the database and the advanced map information storage unit of the roadside device 7 updated via the communication unit so that the contents are synchronized with those of the database 32 and the advanced map information storage unit 33 of the control center 5.

### 1-5. Configuration of Traveling Path Generation Unit 21

Next, the traveling path generation unit 21 of the in-vehicle system 1 will be described.

As illustrated in FIG. 3, the traveling path generation unit 21 includes an information acquisition section 41, a road determination section 42, a path generation section 43, a target recognition section 44, a closest approach estimation section 45, and a spacing setting section 46 as a functional configuration that is implemented when the CPU 25 performs various processes. The path generation section 43 includes a first correction section 47 and a second correction section 48. Some or all of these functions provided by the traveling path generation unit 21 may be carried out on hardware using one or more electric circuits such as logic circuits and ICs. In other words, the traveling path generation unit 21 does not necessarily provide the above functions using software, but can provide the functions using hardware or a combination of software and hardware.

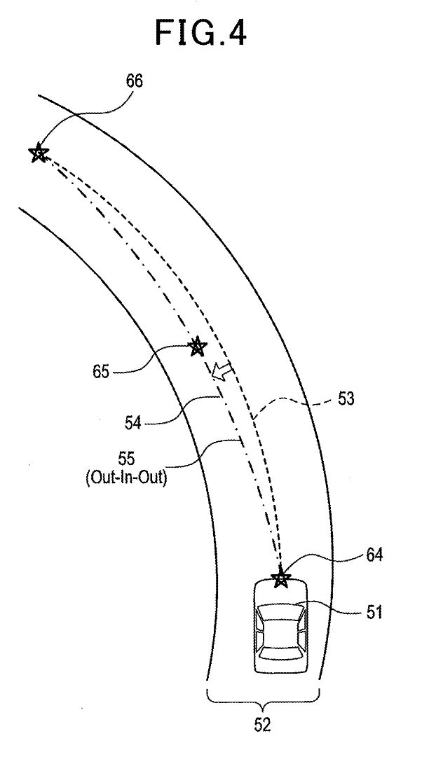

The information acquisition section 41 is configured to acquire road line shape information representing a road line shape of a path (hereinafter referred to as a lane traveling path 53 indicating the middle position of an object lane 52. The object lane 52 is a lane in which an object vehicle 51 is traveling along a traveling path set in advance. In the present embodiment, the traveling path is repeatedly set by the operation management unit 24 on the basis of traveling paths transmitted from the infrastructure 3 and various types of information obtained from the sensor 13. In the present embodiment, as illustrated in FIG. 4, the object vehicle 51 corresponds to the own vehicle. The object lane 52 corresponds to an own lane. The road line shape is a line shape element indicating a planar shape of a road, and indicates straight and curved lines using the radius of curvature. The lane traveling path 53 is a traveling path set by the operation management unit 24, and is information indicating a path connecting middle points in the lane width direction of the object lane.

The road determination section 42 is configured to determine whether there are one or more curved paths on the basis of the road line shape information acquired by the information acquisition section 41. The curved path is a curved line path defined by the radius of curvature within a path range set in advance in the traveling direction from the current position of the object vehicle 51 on the lane traveling path 53. The path range is represented, for example, as a distance on the lane traveling path 53. The path range may be fixed or variable, and if variable, the distance increases with an increase in the speed of the object vehicle 51, for example.

The path generation section 43 is configured to generate a path (hereinafter referred to as an expected traveling path 54) on which the object vehicle 51 is expected to travel along the object lane 52 within the path range. In the present embodiment, the expected traveling path 54 is information indicating a path connecting points (hereinafter referred to as expected passage points) through which the center portion in the lane width direction of the front end of the object vehicle 51 is expected to pass on the object lane. The expected passage points do not necessarily correspond to the center portion of the front end. Specifically, the passage expected points constituting the expected traveling path 54 may be points through which predetermined one of the right and left wheels passes, or may be points through which the gravity center of the object vehicle 51 passes. If the road determination section 42 determines that there is no curved path within the path range, the path generation section 43 sets the lane traveling path 53 as the expected traveling path 54. Consequently, in a case where the length of a continuous straight line path (hereinafter referred to as a straight path) is equal to or more than a length set in advance, the expected traveling path 54 indicating the middle position of the object lane 52 is generated.

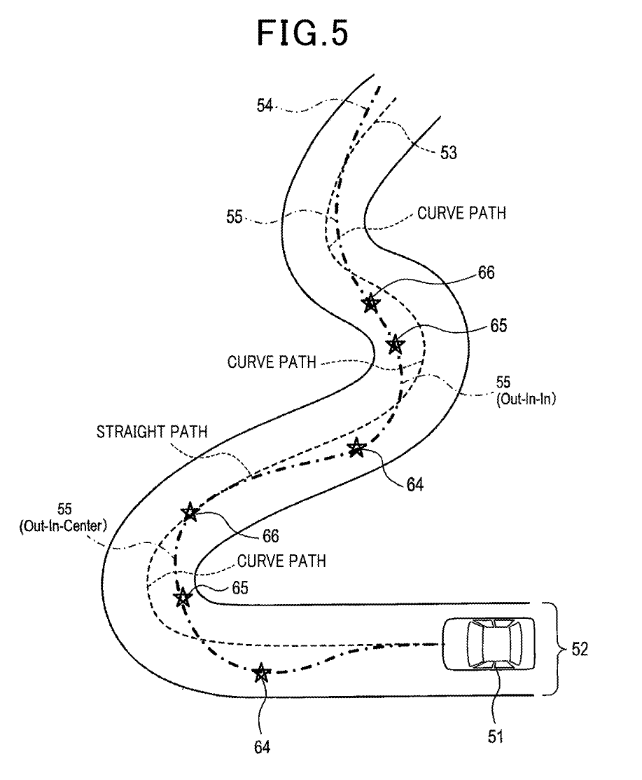

In response to the road determination section 42 determining that there are one or more curved paths within the path range, the first correction section 47 is configured to set, as a cornering line 55, the part of the expected traveling path 54 corresponding to each curved path as illustrated in FIG. 5. The first correction section 47 is configured to correct the lane traveling path 53 such that the radius of curvature of each cornering line 55 exceeds the radius of curvature of the corresponding curved path. Consequently, the expected traveling path 54 is generated which indicates each position in the object lane 52 shifted from the middle position of the object lane 52 corresponding to a curved path to the side where the path has a larger radius of curvature.

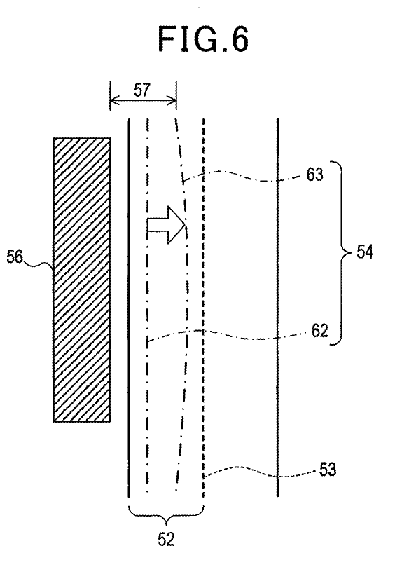

The target recognition section 44 is configured to recognize, as a close target 56, a target located ahead of the object vehicle 51 and close to the object lane 52. The target is a predetermined object detected by the sensor 13. In the present embodiment, the target is a structure such as a noise barrier, a tunnel wall, a building, premises, a guardrail, and a pole, a vehicle, a pedestrian, or the like. In the present embodiment, as illustrated in FIG. 6, the close target 56 is a target that exists at a point where the distance to the expected traveling path 54 corrected by the first correction section 47 is shorter than a predetermined threshold value (hereinafter referred to as an initial value of a safe spacing 57). The safe spacing 57 is a spacing in the lane width direction with respect to the close target 56. The safe spacing 57 is compared with the distance to the expected traveling path 54 in the present embodiment. Alternatively, the safe spacing 57 may be compared with the distance to the path obtained by shifting the expected traveling path 54 toward the close target 56 by half the width of the object vehicle 51. The safe spacing 57 may be fixed, but is assumed to be variable in the example described in the present embodiment.

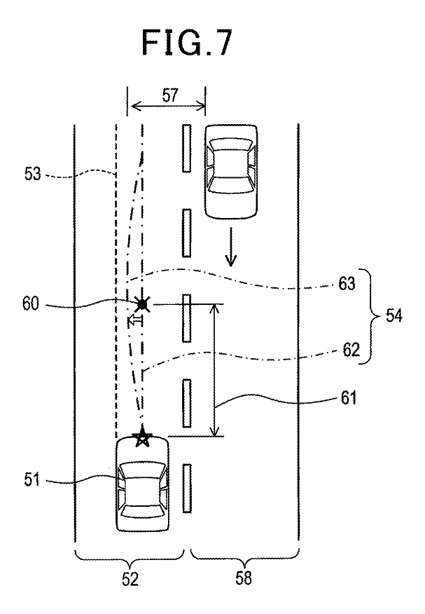

In a case where the close target 56 is an adjacent vehicle 59, the closest approach estimation section 45 is configured to estimate, as a closest approach position 60, the position on the lane traveling path 53 where the object vehicle 51 is closest to the adjacent vehicle 59. An adjacent lane 58 is a lane adjacent to the object lane 52. The adjacent vehicle 59 is a vehicle traveling in the adjacent lane 58. The closest approach estimation section 45 calculates the time that elapses before the object vehicle 51 comes closest to the adjacent vehicle 59 on the basis of, for example, the history of the relative position and relative speed to the adjacent vehicle 59 detected by the sensor 13, and multiplies the calculated time by the speed of the object vehicle 51, thereby predicting a reach distance 61 from the current position of the object vehicle. As illustrated in FIG. 7, the closest approach estimation section 45 sets, as the closest approach position 60, the position on the lane traveling path 53 corresponding to the reach distance 61. The closest approach estimation section 45 does not necessarily estimate the closest approach position 60 with respect to the adjacent vehicle 59, but may designate a pedestrian walking on a sidewalk adjacent to the object lane 52 as an adjacent pedestrian to estimate the closest approach position 60 with respect to the adjacent pedestrian in a similar manner. The adjacent vehicle 59 and the adjacent pedestrian in this example correspond to moving objects. The moving object is defined as a dynamic object capable of moving by itself.

The spacing setting section 46 is configured to set the safe spacing 57. The method of setting the safe spacing 57 will be described later.

The second correction section 48 is configured to correct the lane traveling path 53 such that the spacing in the lane width direction with respect to the close target 56 recognized by the target recognition section 44 becomes equal to or larger than the predetermined safe spacing 57. In the present embodiment, as illustrated in FIGS. 6 and 7, the second correction section 48 sets, as a first correction path 62, the lane traveling path 53 corrected by the first correction section 47, that is, the expected traveling path 54 generated by the first correction section 47. The second correction section 48 generates a second correction path 63 by further correcting the first correction path 62 such that the spacing in the lane width direction with respect to the close target 56 recognized by the target recognition section 44 becomes equal to or larger than the safe spacing 57. The second correction path 63 generated by the second correction section 48 is output to the automated traveling control unit 22 as the expected traveling path 54 of the object vehicle 51. Note that in a configuration without the second correction section 48, the first correction path 62 generated by the first correction section 47 is output to the automated traveling control unit 22 as the expected traveling path 54 of the object vehicle 51.

### 1-6. Processes

### 1-6-1. First Correction Path Generating Process

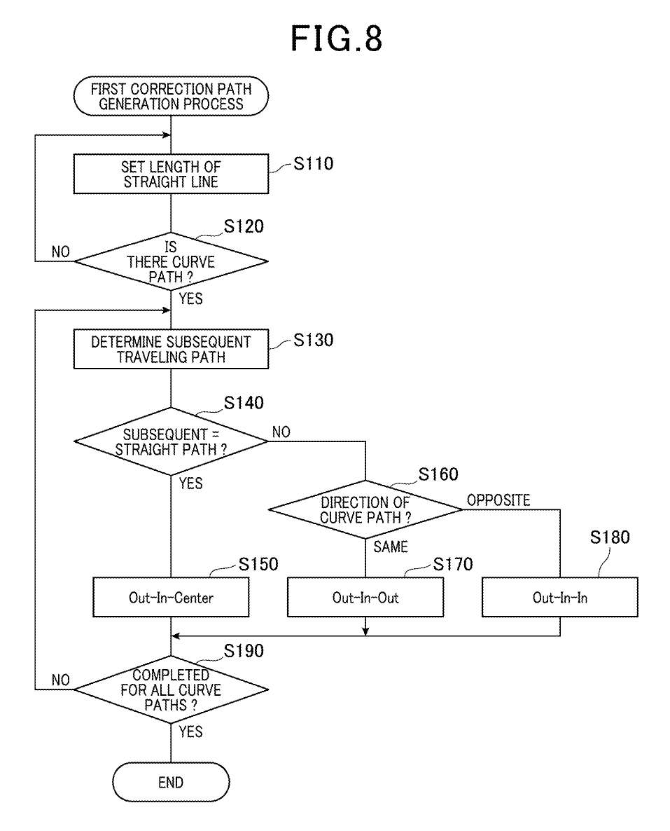

Next, a first correction path generation process that is performed by the CPU 25 of the traveling path generation unit 21 will be described with reference to the flowchart of FIG. 8. This process is repeatedly performed in each predetermined cycle while the intention to utilize the automated driving function is confirmed via the input device 17.

The process is started in S110, where the road determination section 42 sets the length of a straight line regarded as a straight path in accordance with the speed of the object vehicle 51. The straight line is a line segment whose radius of curvature is equal to or larger than a threshold value. The straight path is a series of line segments whose entire length is equal to or longer than a predetermined length, where each of the line segments has a radius of curvature equal to or larger than the threshold value. In this example, the predetermined length is variably set in accordance with the speed of the object vehicle 51. Specifically, the larger the speed of the object vehicle 51, the larger the length of the straight line. The speed of the object vehicle 51 is obtained from a detection result provided by the sensor 13.

Next, the road determination section 42 determines in S120 whether there are one or more curved paths within the path range. Specifically, the road determination section 42 compares the radius of curvature of each of the line segments constituting the lane traveling path 53 within the path range with the threshold value, and determines that there is a curved path if there is a line segment whose radius of curvature is smaller than the threshold value. The radius of curvature is obtained from the contents stored in the advanced map information storage section 14 and a result of recognizing lane boundaries provided by the sensor 13. Instead of determining that the subsequent traveling path is a curved path if there is a line segment whose radius of curvature is smaller than the threshold value, the road determination section 42 may determine that the subsequent traveling path is a curved path if the entire length of a series of line segments each having a radius of curvature smaller than the threshold value is equal to or longer than a predetermined length. If the road determination section 42 determines that there is a curved path, the process advances to S130. If the road determination section 42 determines in S120 that there is no curved path, the path generation section 43 generates the lane traveling path 53 as the expected traveling path 54 without correcting the lane traveling path 53 within the path range. After that, the process returns to S110.

In S130, the road determination section 42 sets curved paths as entry curves in ascending order of the distance from the current position of the object vehicle 51, and determines the type of a path (hereinafter referred to as a subsequent traveling path) subsequent to each of the entry curves on the lane traveling path. Specifically, the road determination section 42 compares, with a threshold value, the radius of curvature of each line segment constituting the lane traveling path 53 subsequent to the entry curve within the path range, and determines that the subsequent traveling path is a straight path if the entire length of a series of line segments each having a radius of curvature equal to or larger than the threshold value is equal to or longer than the length set in S110. Before the road determination section 42 determines that the subsequent traveling path is a straight path, for example, if there is a line segment whose radius of curvature is smaller than a threshold value, the road determination section 42 determines that the subsequent traveling path is a curved path. The threshold value for straight path determination may be larger than or equal to the threshold value for curved path determination. If the road determination section 42 determines in S130 that the subsequent traveling path is a curved path, the road determination section 42 determines the direction of the curved path. The direction of the curved path is obtained from the contents stored in the advanced map information storage section 14 and a result of recognizing lane boundaries provided by the sensor 13. Instead of determining that the subsequent traveling path is a curved path if there is a line segment whose radius of curvature is smaller than the threshold value, the road determination section 42 may determine that the subsequent traveling path is a curved path if the entire length of a series of line segments each having a radius of curvature smaller than the threshold value is equal to or longer than a predetermined length. In the present embodiment, the road determination section 42 sets curved paths as entry curves in ascending order of the distance from the current position of the object vehicle 51. Alternatively, for example, the road determination section 42 may continue the process by setting curved paths as entry curves in descending order of the distance from the current position of the object vehicle 51.

In S140, if the road determination section 42 determines that the subsequent traveling path is a straight path, the process advances to S150. If the road determination section 42 determines that the subsequent traveling path is a curved path, the process advances to S160 and further to S170 or S180.

In the following steps, the first correction section 47 sets, as a clipping point 65, the innermost point of the cornering line 55 with respect to the center of curvature of a curved path in the object lane 52. On the basis of the determination result in S130, the first correction section 47 sets an entrance point 64 and an exit point 66 of the cornering line 55 corresponding to an entry curve in accordance with the type of subsequent traveling path. Specifically, the first correction section 47 generates the cornering line 55 such that the object vehicle 51 travels through the entrance point 64, the clipping point 65, and the exit point 66 in this order under the condition that the width of the object vehicle 51 falls within the width of the object lane 52 corresponding to an entry curve. At this time, the lane traveling path 53 is corrected such that the radius of curvature of the cornering line 55 exceeds the radius of curvature of the corresponding curved path. In a case where the curved path has a plurality of radius of curvature, the lane traveling path 53 is corrected such that the radius of curvature of each of the line segments constituting the cornering line 55 exceeds the radius of curvature of each of the line segments constituting the curvature path. The first correction section 47 may correct the entrance point 64, the clipping point 65, and the exit point 66 such that the rate of change of lateral acceleration at each point on the cornering line 55 becomes equal to or smaller than a predetermined rate of change on the basis of a target value set by the automated traveling control unit 22.

In S150, the first correction section 47 sets the entrance point 64 of the cornering line 55 corresponding to an entry curve at an outer point of the object lane 52 with respect to the center of curvature of the entry curve, and sets the exit point 66 at the middle point of the object lane 52. Consequently, in a case where the subsequent traveling path of an entry curve is a straight path, what is called an out-in-center cornering line 55 is generated. As illustrated in FIG. 5, the out-in-center cornering line 55 has the entrance point 64 at an outer point of the entry curve, the clipping point 65 at an inner point of the entry curve, and the exit point 66 at the middle point with respect to the lane traveling path 53.

In S160, if the road determination section 42 determines that a curved path as the subsequent traveling path bends in the same direction as an entry curve, the process advances to S170. If the road determination section 42 determines that the curved path as the subsequent traveling path bends in the opposite direction of the entry curve, the process advances to S180.

In S170, the first correction section 47 sets the entrance point 64 of the cornering line 55 corresponding to an entry curve to an outer point of the object lane 52 with respect to the center of curvature of the entry curve. The first correction section 47 sets the exit point 66 of the cornering line 55 corresponding to the entry curve to an outer point of the object lane 52 with respect to the center of curvature of the entry curve. Consequently, in a case where the subsequent traveling path of an entry curve is a curved path bending in the same direction as the entry curve, what is called an out-in-out cornering line 55 is generated. As illustrated in FIG. 4, the out-in-out cornering line 55 has the entrance point 64 at an outer point of the entry curve, the clipping point 65 at an inner point of the entry curve, and the exit point 66 at an outer point of the entry curve with respect to the lane traveling path 53.

In S180, the first correction section 47 sets the entrance point 64 of the cornering line 55 corresponding to an entry curve to an outer point of the object lane 52 with respect to the center of curvature of the entry curve. The first correction section 47 sets the exit point 66 of the cornering line 55 corresponding to the entry curve to an inner point of the object lane 52 with respect to the center of curvature of the entry curve. Consequently, in a case where the subsequent traveling path of an entry curve is a curved path bending in the opposite direction of the entry curve, what is called an out-in-in cornering line 55 is generated. As illustrated in FIG. 5, the out-in-in cornering line 55 has the entrance point 64 at an outer point of the entry curve, the clipping point 65 at an inner point of the entry curve, and the exit point 66 at an inner point of the entry curve with respect to the lane traveling path 53.

In S190, the path generation section 43 determines whether cornering lines 55 have been generated for all the curved paths within the path range. If the path generation section 43 determines that the cornering lines 55 have been generated for all the curved paths, the process is finished. If the path generation section 43 determines that the cornering lines 55 have not been generated for one or more curved paths, the process returns to S130. After returning to S130, the path generation section 43 generates the cornering lines 55 for such curved paths in ascending or descending order of the distance from the current position of the object vehicle 51 in a manner similar to that in S130 to S180.

As described above, in the first correction path generating process, if there is a curved path within the path range, the traveling path generation unit 21 generates the cornering line 55 in accordance not only with the road line shape of the entry curve but also with the type of subsequent traveling path. In this manner, the traveling path generation unit 21 corrects the lane traveling path 53 to generate the first correction path 62.

### 1-6-2. Second Correction Path Generating Process

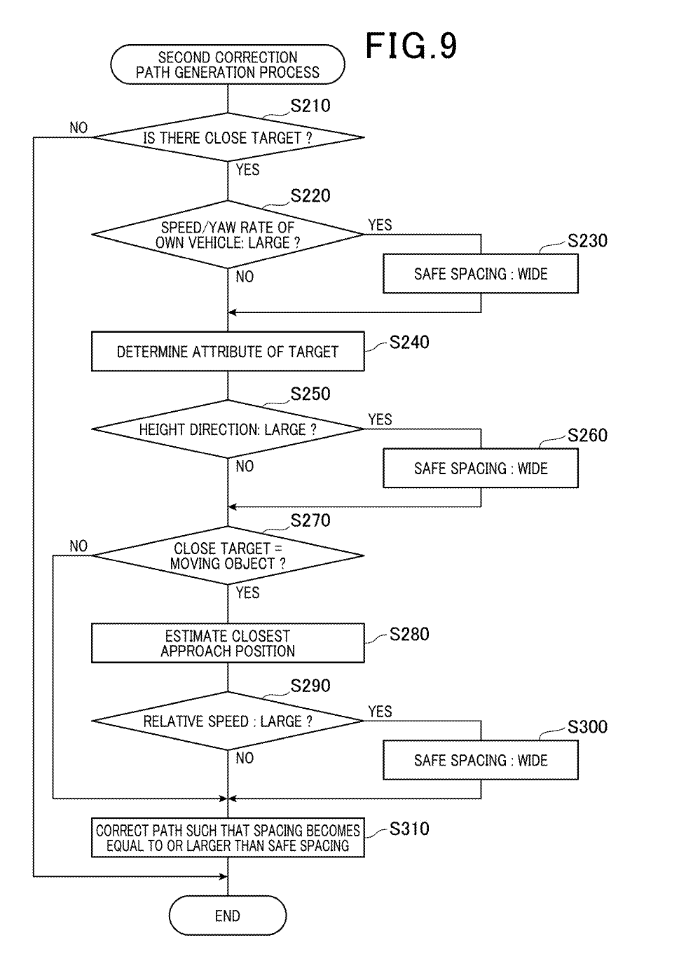

Next, a second correction path generating process that is performed by the CPU 25 of the traveling path generation unit 21 will be described with respect to the flowchart of FIG. 9. This process is repeatedly performed in each predetermined cycle while the intention to utilize the automated driving function is confirmed via the input device 17. Note that the first correction path 62 is corrected in the example described in the present embodiment. Alternatively, the traveling path generation unit 21 may directly correct the lane traveling path 53.

The process is started in S210, where the target recognition section 44 recognizes, as the close target 56, a target that exists at a point where the distance to the first correction path 62 is shorter than the initial value of the safe spacing 57. If the spacing setting section 46 determines that the close target 56 exists within the path range on the basis of the recognition result, the process advances to S220. If the spacing setting section 46 determines that no close target 56 exists, the process is finished. The position of a target is obtained from a result of detecting an object provided by the sensor 13. A well-known method such as pattern matching is used for recognizing a target. A method for recognizing the close target 56 may include comparing the distance to the lane boundary which is closer to the target than the other lane boundary constituting the object lane 52 with the initial value of the safe spacing 57, instead of the above method.

In S220, the spacing setting section 46 determines whether at least one of the speed and yaw rate of the object vehicle 51 is larger than a predetermined threshold value. If the spacing setting section 46 determines that at least one of the speed and yaw rate of the object vehicle 51 is larger than the threshold value, the process advances to S230. If the spacing setting section 46 determines that both the speed and yaw rate of the object vehicle 51 are equal to or less than the threshold value, the process advances to S240. The threshold value for this step is individually determined for each of the speed and yaw rate of the object vehicle 51. The speed and yaw rate are obtained from a result of detecting the behavior of the object vehicle 51 provided by the sensor 13. The spacing setting section 46 may subject only one of the speed and yaw rate of the object vehicle 51 to comparison with the threshold value, or may skip S220 and go to S230 and further to S240.

In S230, the spacing setting section 46 sets a first correction value such that the larger at least one of the speed and yaw rate of the object vehicle 51, the wider the safe spacing 57. The spacing setting section 46 sets a new safe spacing 57 by adding the first correction value to the initial value of the safe spacing 57. In other words, the spacing setting section 46 increases the safe spacing 57 with an increase in at least one of the speed and yaw rate of the object vehicle 51. Specifically, the safe spacing 57 is set in the area covering the close target 56 and corresponding, for example, to the length of the close target 56.

In S240, the target recognition section 44 determines the attributes of the close target 56 recognized in S210. Examples of attributes of the close target 56 include the above-mentioned types such as a structure, a vehicle, and a pedestrian, and the height and length of the close target 56. For example, the height and length of the close target 56 are calculated from image data or acquired from the advanced map information storage section 14. The length of the close target 56 means the length in the direction along the object lane 52

In S250, the spacing setting section 46 determines whether the height of the close target 56 is larger than a predetermined threshold value on the basis of the determination result in S240. If the spacing setting section 46 determines that the height of the close target 56 is larger than the threshold value, the process advances to S260. If the spacing setting section 46 determines that the height of the close target 56 is equal to or less than the threshold value, the process advances to S270. The spacing setting section 46 may skip S250 and go to S260 and further to S270.

In S260, on the basis of the determination result in S240, the spacing setting section 46 sets a second correction value such that the larger the close target 56 in the height direction, the wider the safe spacing 57. The spacing setting section 46 sets a new safe spacing 57 by adding the second correction value to the initial value of the safe spacing 57 or the safe spacing 57 set in S230. In other words, the spacing setting section 46 increases the safe spacing 57 with an increase in the height of the close target 56. Specifically, the safe spacing 57 is set in the area covering the close target 56 and corresponding, for example, to the length of the close target 56. Further, the spacing setting section 46 may increase the safe spacing 57 with an increase in the length of the close target 56.

In S270, the spacing setting section 46 determines whether the close target 56 is a moving object such as the adjacent vehicle 59 and an adjacent pedestrian on the basis of the determination result in S240.

If the spacing setting section 46 determines that the close target 56 is a moving object, the process advances to S280. If the spacing setting section 46 determines that the close target 56 is not a moving object, the process advances to S310.

In S280, the closest approach estimation section 45 estimates, as the closest approach position 60, the position where the moving object in S270 is closest to the object vehicle 51 on the first correction path 62. The method of estimating the closest approach position 60 is as described above.

In S290, assuming that the side where the moving object in S270 approaches the object vehicle 51 is positive, the spacing setting section 46 determines whether the relative speed of the moving object to the object vehicle 51 is more than a predetermined threshold value. If the spacing setting section 46 determines that the relative speed of the moving object is larger than the threshold value, the process advances to S300. If the spacing setting section 46 determines that the relative speed of the moving object is equal to or smaller than the threshold value, the process advances to S310. The spacing setting section 46 may skip S290 and go to S300 and further to S310.

In S300, the spacing setting section 46 sets a third correction value such that the larger the relative speed of the moving object in S290, the wider the safe spacing 57. The spacing setting section 46 sets a new safe spacing 57 by adding the third correction value to the initial value of the safe spacing 57, the safe spacing 57 set in S230, or the safe spacing 57 set in S260. In other words, the spacing setting section 46 increases the safe spacing 57 with an increase in the approaching speed of the moving object. The spacing setting section 46 sets the safe spacing 57 at the closest approach position 60 estimated in S280. Specifically, the safe spacing 57 is set in the area covering the closest approach position 60 and corresponding, for example, to the length of the moving object.

In S310, the second correction section 48 obtains information on the safe spacing 57 newly set in at least one of the steps S230, S260, and S300 or on the initial value of the safe spacing 57. The second correction section 48 generates the second correction path 63 by correcting the first correction path 62 such that the spacing in the lane width direction with respect to the close target 56 becomes equal to or larger than the safe spacing 57. Specifically, for example, in a case where the close target 56 is a structure, as illustrated in FIG. 6, the first correction path 62 is corrected such that the spacing in the lane width direction with respect to the close target 56 becomes equal to or larger than the safe spacing 57 in the area corresponding to the length of the close target 56. For example, in a case where the close target 56 is the adjacent vehicle 59, as illustrated in FIG. 7, the first correction path 62 is corrected such that the spacing in the lane width direction with respect to the close target 56 becomes equal to or larger than the safe spacing 57 in the area corresponding to the length of the adjacent vehicle 59 around the closest approach position 60.

### 1-7. Effects

According to the first embodiment described in detail above, the following effects are obtained.

(1a) The radius of curvature of the cornering line 55 on the expected traveling path 54 is larger than the radius of curvature of the lane traveling path 53 indicating the middle position of a lane as a traveling path for the vehicle. Therefore, the lateral force (hereinafter referred to as lateral acceleration) applied to the vehicle during cornering is reduced, and vehicle ride quality can be improved. In addition, since the lateral acceleration is reduced, tire wear can be reduced. Moreover, since the vehicle is relatively less decelerated, vehicle fuel consumption can be improved.

(2a) The cornering lines 55 are sequentially generated in accordance not only with the road line shapes of entry curves but also with the types of subsequent traveling paths. Therefore, vehicle ride quality and the like can be improved not only on the basis of previous traveling roads but also in consideration of optimization in the entire path range.

(3a) For example, in a case where the subsequent traveling path is a straight path, what is called an out-in-center cornering line 55 is generated. Therefore, the vehicle can smoothly travel in the middle of the object lane 52 on the straight path subsequent to an entry curve.

(4a) For example, in a case where the subsequent traveling path is a curved path bending in the same direction as an entry curve, what is called an out-in-out cornering line 55 is generated. For example, in a case where the subsequent traveling path is a curved path bending in the direction opposite to an entry curve, what is called an out-in-in cornering line 55 is generated. In either case, the entrance point 64 is set to an outer point of the curved path subsequent to the entry curve. Therefore, the vehicle can smoothly travel through the entrance point 64 to the clipping point 65 on the subsequent traveling path.

(5a) During the determination of straight and curved paths, a traveling path having a straight length that depends on the speed of the vehicle is regarded as a straight path, not as a curved path. Therefore, the function of generating the cornering line 55 is inactivated as appropriate according to the traveling state of the vehicle. Thus, unnecessary processing load can be removed.

### 2. Other Embodiments

The embodiment for implementing the present disclosure has been described so far. The present disclosure is not limited to the above embodiment, but can be variously modified in practice.

(2A) In the above embodiment, the cooperative automated driving control system including the infrastructure 3 and the in-vehicle system 1 which cooperate with each other to generate the expected traveling path 54 has been described as an example. However, the present disclosure is not limited to this example. For example, the in-vehicle system 1 may independently generate the expected traveling path 54 as what is called an autonomous automated driving control system. In addition, the present disclosure is not limited to the automated driving control systems. The traveling path generation unit 21 may generate the expected traveling path 54 in other traveling control systems in which drivers perform driving operations.

(2B) The function of a single component in the above embodiment may be shared by a plurality of components, or the functions of a plurality of components may be fulfilled by a single component. Some of the configurations in the above embodiment may be omitted. At least some of the configurations in the above embodiment may be added to or replaced by other configurations in the above embodiment. Every aspect included in the technical idea specified only by the wordings described in the claims is an embodiment of the present disclosure.

(2C) In addition to the above-mentioned traveling path generation unit 21, the present disclosure can be implemented in various forms such as the in-vehicle system 1 including the traveling path generation unit 21 as a component, one or more programs for allowing a computer to function as the traveling path generation unit 21, one or more non-transitory tangible recording media such as semiconductor memories that store at least some of these programs, and a traveling path generation method.

(2D) Alternatively, the present disclosure can be implemented in another form in which the infrastructure 3 such as the control center 5 and the roadside unit 7 includes the traveling path generation unit 21 to wirelessly transmit the generated expected traveling path 54 to each vehicle.

1. A traveling path generation apparatus comprising:
an information acquisition section that sets, as an object lane, a lane in which an object vehicle is traveling along a traveling path set in advance, and acquires road line shape information representing a line shape of a lane traveling path indicating a middle position of the object lane;
a road determination section that determines, on the basis of the road line shape information acquired by the information acquisition section, whether there are one or more curved paths within a path range set in advance in a traveling direction from a current position of the object vehicle on the lane traveling path, each of the curved paths being defined by a radius of curvature; and
a path generation section that generates, in response to the road determination section determining that there are one or more curved paths, an expected traveling path of the object vehicle within the path range, wherein
the path generation section causes a radius of curvature of each cornering line corresponding to each of the curved paths on the expected traveling path to exceed a radius of curvature of the corresponding curved path, and
in response to the road determination section determining that there is the curved path within the path range and that a subsequent traveling path subsequent to the curved path is a straight path that is a straight line path having a length equal to or longer than a length set in advance, the path generation section is further adapted to set an entrance point of the cornering line corresponding to the curved path on a width-directional curve outer side inside the lane in which the object vehicle is traveling, and set an exit point of the cornering line at in width-directional curve middle inside the lane in which the object vehicle is traveling.

2. The traveling path generation apparatus comprising:
an information acquisition section that sets, as an object lane, a lane in which an object vehicle is traveling along a traveling path set in advance, and acquires road line shape information representing a line shape of a lane traveling path indicating a middle position of the object lane;
a road determination section that determines, on the basis of the road line shape information acquired by the information acquisition section, whether there are one or more curved paths within a path range set in advance in a traveling direction from a current position of the object vehicle on the lane traveling path, each of the curved paths being defined by a radius of curvature; and
a path generation section that generates, in response to the road determination section determining that there are one or more curved paths, an expected traveling path of the object vehicle within the path range, wherein
the path generating section causes a radius of curvature of each cornering line corresponding to each of the curved paths on the expected traveling path to exceed a radius of curvature of the corresponding curved path, and
in response to the road determination section determining that there is a first curved path within the path range, that a subsequent traveling path subsequent to the first curved path is a second curved path drawing a curved line different from a curved line of the first curved path, and that the first curved path and the second curved path bend in a same direction, the path generating section is further adapted to set an entrance point and an exit point of the cornering line corresponding to the first curved path on a width-directional curve outer side inside the lane in which the object vehicle is traveling.

3. The traveling path generation apparatus comprising:
an information acquisition section that sets, as an object lane, a lane in which an object vehicle is traveling along a traveling path set in advance, and acquires road line shape information representing a line shape of a lane traveling path indicating a middle position of the object lane;
a road determination section that determines, on the basis of the road line shape information acquired by the information acquisition section, whether there are one or more curved paths within a path range set in advance in a traveling direction from a current position of the object vehicle on the lane traveling path, each of the curved paths being defined by a radius of curvature; and
a path generation section that generates, in response to the road determination section determining that there are one or more curved paths, an expected traveling path of the object vehicle within the path range, wherein
the path generating section causes a radius of curvature of each cornering line corresponding to each of the curved paths on the expected traveling path to exceed a radius of curvature of the corresponding curved path, and
in response to the road determination section determining that there is a first curved path within the path range, that a subsequent traveling path subsequent to the first curved path is a second curved path drawing a curved line different from a curved line of the first curved path, and that the first curved path and the second curved path bend in opposite directions, the path generation section is further adapted to set an entrance point of the cornering line corresponding to the first curved path on a width-directional curve outer side inside the lane in which the object vehicle is traveling, and set an exit point of the cornering line corresponding to the first curved path on a curve inner side inside the lane in which the object vehicle is traveling.

4. The traveling path generation apparatus according to claim 1 wherein
the path generation section is adapted to set, as a clipping point, an innermost point of the cornering line with respect to a center of curvature of the curved path in the object lane, and set, on the basis of a determination result provided by the road determination section, the entrance point and the exit point of the cornering line corresponding to the curved path leading to the subsequent traveling path in accordance with a type of the subsequent traveling path.

5. The traveling path generation apparatus according to claim 2, wherein
the path generation section is adapted to set, as a clipping point, an innermost point of the cornering line with respect to a center of curvature of the curved path in the object lane, and set, on the basis of a determination result provided by the road determination section, the entrance point and the exit point of the cornering line corresponding to the curved path leading to the subsequent traveling path in accordance with a type of the subsequent traveling path.

6. The traveling path generation apparatus according to claim 3, wherein
the path generation section is adapted to set, as a clipping point, an innermost point of the cornering line with respect to a center of curvature of the curved path in the object lane, and set, on the basis of a determination result provided by the road determination section, the entrance point and the exit point of the cornering line corresponding to the curved path leading to the subsequent traveling path in accordance with a type of the subsequent traveling path.

7. The traveling path generation apparatus according to claim 1, wherein
the road determination section is adapted to set a length of a straight line regarded as the straight path in accordance with a speed of the object vehicle.

8. A traveling path generation method comprising:
an information acquiring step of acquiring road line shape information representing a line shape of a lane traveling path indicating a middle position of a lane in which an object vehicle is traveling;
a road determining step of determining, on the basis of the road line shape information acquired by the information acquiring step, whether there are one or more curved paths within a path range set in advance in a traveling direction from a current position of the object vehicle on the lane traveling path, each of the curved paths being defined by a radius of curvature; and
a path generating step of generating, in response to the road determining step determining that there are one or more curved paths, an expected traveling path of the object vehicle within the path range, wherein
the path generating step generates the expected traveling path such that a radius of curvature of each cornering line corresponding to each of the curved paths on the expected traveling path exceeds a radius of curvature of the corresponding curved path, and
in response to the road determining step determining that there is the curved path within the path range and that a subsequent traveling path subsequent to the curved path is a straight path that is a straight line path having a length equal to or longer than a length set in advance, the path generating step further sets an entrance point of the cornering line corresponding to the curved path on a width-directional curve outer side inside the lane in which the object vehicle is traveling, and sets an exit point of the cornering line in a width-directional curve middle inside the lane in which the object vehicle is traveling.

9. A traveling path generation method comprising:
an information acquiring step of acquiring road line shape information representing a line shape of a lane traveling path indicating a middle position of a lane in which an object vehicle is traveling;
a road determining step of determining, on the basis of the road line shape information acquired by the information acquiring step, whether there are one or more curved paths within a path range set in advance in a traveling direction from a current position of the object vehicle on the lane traveling path, each of the curved paths being defined by a radius of curvature; and
a path generating step of generating, in response to the road determining step determining that there are one or more curved paths, an expected traveling path of the object vehicle within the path range, wherein
the path generating step generates the expected traveling path such that a radius of curvature of each cornering line corresponding to each of the curved paths on the expected traveling path exceeds a radius of curvature of the corresponding curved path, and
in response to the road determining step determining that there is a first curved path within the path range, that a subsequent traveling path subsequent to the first curved path is a second curved path drawing a curved line different from a curved line of the first curved path, and that the first curved path and the second curved path bend in a same direction, the path generating step further sets an entrance point and an exit point of the cornering line corresponding to the first curved path on a width-directional curve outer side inside the lane in which the object vehicle is traveling.

10. A traveling path generation method comprising:
an information acquiring step of acquiring road line shape information representing a line shape of a lane traveling path indicating a middle position of a lane in which an object vehicle is traveling;
a road determining step of determining, on the basis of the road line shape information acquired by the information acquiring step, whether there are one or more curved paths within a path range set in advance in a traveling direction from a current position of the object vehicle on the lane traveling path, each of the curved paths being defined by a radius of curvature; and
a path generating step of generating, in response to the road determining step determining that there are one or more curved paths, an expected traveling path of the object vehicle within the path range, wherein
the path generating step generates the expected traveling path such that a radius of curvature of each cornering line corresponding to each of the curved paths on the expected traveling path exceeds a radius of curvature of the corresponding curved path, and
in response to the road determining step determining that there is a first curved path within the path range, that a subsequent traveling path subsequent to the first curved path is a second curved path drawing a curved line different from a curved line of the first curved path, and that the first curved path and the second curved path bend in opposite directions, the path generating step further sets an entrance point of the cornering line corresponding to the first curved path on a width-directional curve outer side inside the lane in which the object vehicle is traveling, and sets an exit point of the cornering line corresponding to the first curved path on a curve inner side inside the lane in which the object vehicle is traveling.
